(19) United States
(12) Patent Application Publication
(10) Pub. No.: US 2025/0056019 A1
(43) Pub. Date: Feb. 13, 2025

(54) CHROMA FORMAT ADAPTATION

(71) Applicant: InterDigital CE Patent Holdings, SAS, Paris (FR)

(72) Inventors: Philippe Bordes, Laille (FR); Franck Galpin, Thorigne-Fouillard (FR); Tangi Poirier, Thorigne-Fouillard (FR)

(21) Appl. No.: 18/717,706

(22) PCT Filed: Dec. 1, 2022
(86) PCT No.: PCT/EP2022/084078

§ 371 Date: Jun. 7, 2024

(30) Foreign Application Priority Data
Dec. 15, 2021 (EP) 21306777.0

(51) Int. Cl. H04N 19/186; H04N 19/132; H04N 19/182

(52) U.S. Cl. CPC H04N 19/186; H04N 19/132; H04N 19/182

(57) ABSTRACT

A method for decoding a video sequence representing original video data comprising a first picture of the video sequence having a feature related to a chroma component of the first picture different from a same feature related to a chroma component of a second picture of the video sequence, the feature related to a chroma component being representative of a chroma format and/or of a relative position of chroma samples with respect to luma samples.

### 1. TECHNICAL FIELD

At least one of the present embodiments generally relates to a method and an apparatus for controlling a chroma format and/or a relative position of chroma samples with respect to luma samples in a video encoding and decoding application.

### 2. BACKGROUND

To achieve high compression efficiency, video coding schemes usually employ predictions and transforms to leverage spatial and temporal redundancies in a video content. During an encoding, pictures of the video content are divided into blocks of samples (i.e. Pixels), these blocks being then partitioned into one or more sub-blocks, called original sub-blocks in the following. An intra or inter prediction is then applied to each sub-block to exploit intra or inter image correlations. Whatever the prediction method used (intra or inter), a predictor sub-block is determined for each original sub-block. Then, a sub-block representing a difference between the original sub-block and the predictor sub-block, often denoted as a prediction error sub-block, a prediction residual sub-block or simply a residual block, is transformed, quantized and entropy coded to generate an encoded video stream. To reconstruct the video, the compressed data is decoded by inverse processes corresponding to the transform, quantization and entropic coding.

A tool, called Reference Picture Resampling (RPR), adopted for example in the video compression standard VVC (ISO/IEC 23090-3-MPEG-I, Versatile Video Coding/ITU-T H.266), allows changing the picture size of coded pictures on the fly. The pictures are stored in a buffer of decoded pictures, generally called decoded picture buffer (DPB), at their actual coded/decoded size, which may be lower that the size signaled in high-level syntax (HLS) of the bitstream (maximal size specified in sequence header). When a picture being coded with a given size uses for temporal or inter-layer prediction a reference picture that don't have the same size, a reference picture resampling of the texture is applied so that the predicted picture and the reference picture have the same size. Note that depending on the implementation, the resampling process is not necessarily applied to the entire reference picture (entire reference picture resampling) but can be applied only to blocks identified as reference blocks when performing the decoding and reconstruction of the current block (block-based reference picture resampling). In this case, when a current block in the current picture uses reference samples of a reference picture that has a different size than the current picture, the samples in the reference picture that are used for the temporal prediction of the current block are resampled according to resampling ratios computed as ratios between the current size and the reference size.

The steps of RPR and motion compensation may be combined in one single sample interpolation step. This aspect is further detailed in the following in relation to FIGS. 3 and 4.

FIG. 1 represents an application of the RPR tool. In FIG. 1, picture 4 is temporally predicted from picture 3. Picture 3 is temporally predicted from picture 2. Picture 2 is temporally predicted from picture 1. Since picture 4 and picture 3 have different sizes, picture 3 is up-sampled to the size of picture 4. Picture 3 and 2 have the same size. No up-sampling nor down-sampling is applied to picture 2 for the temporal prediction. Picture 1 is larger than picture 2. A down-sampling is applied to picture 1 for the temporal prediction of picture 2. In any case, all pictures are up-sampled or down-sampled at the same size for display.

Color pictures are generally made of three (for example RGB or YUV) components. Traditionally, to reduce the storage space or to facilitate the compression, the chroma components of the picture are sub-sampled by a factor (for example two or four) horizontally and/or vertically compared to an original/canonical 4:4:4 format, because the human eye is less sensitive to signal distortion in chroma components than in a luminance (Y) component. For example, in the 4:2:2 chroma format, the number of chroma samples is sub-sampled by 2 horizontally and in the 4:2:0 chroma format the number of chroma samples is sub-sampled by 2 horizontally and vertically. The size of the chroma component in 4:2:2 chroma format is half the size of the luma component. The size of the chroma component in 4:2:0 chroma format a quarter of the size of the luma component.

In general, when RPR is used, a same down-sampling ratio is applied for all the components. When the input chroma format comprises sub-sampled chroma components (for example 4:2:2, 4:2:0), RPR adds another down-sampling process to the chroma components that were already down-sampled. An issue of this design is that the successive down-sampling applied to the chroma components may lead in objective (for example PSNR (Peak Signal to Noise Ratio) or SSIM (Structural SIMilarity) and/or subjective signal degradations in chroma components that may be unacceptable and may jeopardize the benefit of RPR.

It is desirable to propose solutions allowing to overcome the above issues. In particular, it is desirable to better take into account the effect of successive down-sampling in the RPR process.

### 3. BRIEF SUMMARY

In a first aspect, one or more of the present embodiments provide a method for encoding a video sequence from original video data comprising coding a first picture of the video sequence with a feature related to a chroma component of the first picture different from a same feature related to a chroma component of a second picture of the video sequence, the feature related to a chroma component being representative of a chroma format and/or of a relative position of chroma samples with respect to luma samples.

In a second aspect, one or more of the present embodiments provide a device for encoding a video sequence from original video data comprising electronic circuitry configured for coding a first picture of the video sequence with a feature related to a chroma component of the first picture different from a same feature related to a chroma component of a second picture of the video sequence, the feature related to a chroma component being representative of a chroma format and/or of a relative position of chroma samples with respect to luma samples.

In an embodiment of the first or the second aspect, at least one block of the first picture is temporally predicted from samples of the second picture.

In an embodiment of the first or the second aspect, the chroma format of the first picture depends on a value of a luma resolution ratio between a size of a luma component of the first picture and a size of a luma component of the second picture and a chroma resolution ratio between a size of the chroma component of the first picture and a size of the chroma component of the second picture, the luma resolution ratio and the chroma resolution ratio being different.

In an embodiment of the first or the second aspect, the chroma format of the first picture is signaled in a picture header, a slice header or a picture parameter set to which refers the first picture.

In an embodiment of the first or the second aspect, a chroma format indicated in a sequence header to which refer the video sequence indicates a chroma format associated to a maximum picture size of the video sequence or a chroma format of the original video data.

In an embodiment of the first or the second aspect, the relative position of chroma samples with respect to luma samples is signaled in a picture header, a slice header or a picture parameter set to which refers the first picture.

In an embodiment of the first or the second aspect, the relative position of chroma samples with respect to luma samples is signaled in the picture header or the slice header responsive to the first picture having a chroma format different from the chroma format indicated in the sequence header.

In an embodiment of the first or the second aspect, responsive to the chroma format of the first picture being 4:4:4, the relative position of chroma samples with respect to luma samples is given a default value.

In an embodiment of the first or the second aspect, the chroma format of the first picture is one of 4:4:4 or 4:2:0 or 4:2:2.

In an embodiment of the first or the second aspect, responsive to the chroma format of the first picture being different from the chroma format of the original video data, the chroma format of the first picture is compliant with allowed ratios between a width of pictures of the original video data and a width of the first picture and with allowed ratios between a height of pictures of the original video data and a height of the first picture.

In a third aspect, one or more of the present embodiments provide a method for decoding a video sequence representing original video data comprising decoding a first picture of the video sequence having a feature related to a chroma component of the first picture different from a same feature related to a chroma component of a second picture of the video sequence, the feature related to a chroma component being representative of a chroma format and/or of a relative position of chroma samples with respect to luma samples.

In a fourth aspect, one or more of the present embodiments provide a device for decoding a video sequence representing original video data comprising an electronic circuitry configured for decoding a first picture of the video sequence having a feature related to a chroma component of the first picture different from a same feature related to a chroma component of a second picture of the video sequence, the feature related to a chroma component being representative of a chroma format and/or of a relative position of chroma samples with respect to luma samples.

In an embodiment of the third or the fourth aspect, at least one block of the first picture is temporally predicted from samples of the second picture.

In an embodiment of the third or the fourth aspect, the chroma format of the first picture depends on a value of a luma resolution ratio between a size of a luma component of the first picture and a size of a luma component of the second picture and a chroma resolution ratio between a size of the chroma component of the first picture and a size of the chroma component of the second picture, the luma resolution ratio and the chroma resolution ratio being different.

In an embodiment of the third or the fourth aspect, the chroma format of the first picture is signaled in a picture header, slice header or a picture parameter set to which refers the first picture.

In an embodiment of the third or the fourth aspect, a chroma format signaled in a sequence header to which refer the video sequence indicates a chroma format associated to a maximum picture size of the video sequence or a chroma format of the original video data.

In an embodiment of the third or the fourth aspect, the relative position of chroma samples with respect to luma samples is indicated in a picture header, a slice header or a picture parameter set to which refers the first picture.

In an embodiment of the third or the fourth aspect, the relative position of chroma samples with respect to luma samples is indicated in the picture header or the slice header responsive to the chroma format of the first picture being different from the chroma format indicated in the sequence header.

In an embodiment of the third or the fourth aspect, responsive to the chroma format of the first picture being 4:4:4, the relative position of chroma samples with respect to luma samples is given a default value.

In an embodiment of the third or the fourth aspect, the chroma format of the first picture is one of 4:4:4 or 4:2:0 or 4:2:2.

In an embodiment of the third or the fourth aspect, responsive to the chroma format of the first picture being different from the chroma format of the original video data, the chroma format of the first picture is compliant with allowed ratios between a width of pictures of the original video data and a width of the first picture and with allowed ratios between a height of pictures of the original video data and a height of the first picture.

In a fifth aspect, one or more of the present embodiments provide a method comprising:
obtaining a reconstructed pixel of a picture;
classifying the reconstructed pixel into one category of a plurality of categories based on a value of a luma sample of the reconstructed pixel and values of chroma samples of the reconstructed pixel, the value of the luma sample depending on a candidate position of the luma sample in the picture selected in a set of candidate positions; and,
applying an offset to each sample of the reconstructed pixel based on the category in which is classified the reconstructed pixel, wherein:
a number of candidate positions in the set of candidate positions depends on a chroma format of the picture.

In a sixth aspect, one or more of the present embodiments provide a device comprising an electronic circuitry configured for:
obtaining a reconstructed pixel of a picture;
classifying the reconstructed pixel into one category of a plurality of categories based on a value of a luma sample of the reconstructed pixel and values of chroma samples of the reconstructed pixel, the value of the luma sample depending on a candidate position of the luma sample in the picture selected in a set of candidate positions; and,
applying an offset to each sample of the reconstructed pixel based on the category in which is classified the reconstructed pixel, wherein:
a number of candidate positions in the set of candidate positions depends on a chroma format of the picture.

In an embodiment of the fifth or the sixth aspect, the set comprises a single position when the chroma format is 4:4:4.

In an embodiment of the fifth or the sixth aspect, the single position is a default position.

In an embodiment of the fifth or the sixth aspect, the number of positions in the set is function of a ratio between a number of chroma samples in the picture and a number of luma samples in the picture.

In a seventh aspect, one or more of the present embodiments provide an encoding method comprising the method of the fifth aspect.

In a eighth aspect, one or more of the present embodiments provide an decoding method comprising the method of the fifth aspect.

In a ninth aspect, one or more of the present embodiments provide an encoding device comprising the device of the sixth aspect.

In a tenth aspect, one or more of the present embodiments provide a decoding device comprising the device of the sixth aspect.

In a eleventh aspect, one or more of the present embodiments provides a signal generated by the method of the first aspect or by the method of the seventh aspect or by the device of the second aspect or by the device of the ninth aspect.

In a twelfth aspect, one or more of the present embodiments provides a computer program comprising program code instructions for implementing the method according to the first aspect, the third aspect, the fifth aspect, the seventh aspect or the eighth aspect.

In a thirteenth aspect, one or more of the present embodiments provides a Non-transitory information storage medium storing program code instructions for implementing the method according to the first aspect, the third aspect, the fifth aspect, the seventh aspect or the eighth aspect.

### 4. BRIEF SUMMARY OF THE DRAWINGS

FIG. 1 represents a application of the reference picture resampling tool;

FIG. 2 illustrates schematically an example of partitioning undergone by a picture of pixels of an original video;

FIG. 3 depicts schematically a method for encoding a video stream;

FIG. 4 depicts schematically a method for decoding an encoded video stream;

FIG. 5A illustrates schematically an example of video streaming system in which embodiments are implemented;

FIG. 5B illustrates schematically an example of hardware architecture of a processing module able to implement an encoding module or a decoding module in which various aspects and embodiments are implemented;

FIG. 5C illustrates a block diagram of an example of a first system in which various aspects and embodiments are implemented;

FIG. 5D illustrates a block diagram of an example of a second system in which various aspects and embodiments are implemented;

FIG. 6 represents a plurality of positions that can be taken by a luma sample compared to fixed positions of chroma samples when a picture uses a 4:2:0 chroma format;

FIG. 7 represents phases applied to prediction samples in a line of a picture;

FIG. 8 illustrates schematically an example of method for encoding a video sequence comprising at least two different chroma formats;

FIG. 9 illustrates schematically an example of method for decoding an encoded video sequence comprising at least two different chroma formats;

FIG. 10 illustrates schematically details on the application of RPR;

FIG. 11A represents schematically the centered location of chroma samples; and,

FIG. 11B represents schematically the colocated location of chroma samples.

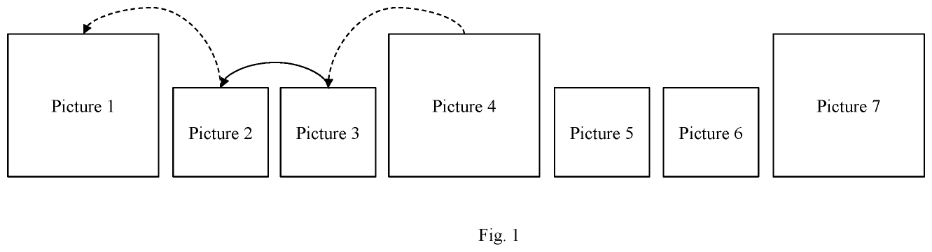

### 5. DETAILED DESCRIPTION

The following examples of embodiments are described in the context of a video format similar to VVC. However, these embodiments are not limited to the video coding/decoding method corresponding to VVC. These embodiments are in particular adapted to any video format allowing generating video streams comprising pictures having different sizes and in which the reconstructed size of a picture could be different from the size used for temporal prediction. Such formats comprise for example the standard HEVC, AVC, EVC (Essential Video Coding/MPEG-5), AV1 and VP9.

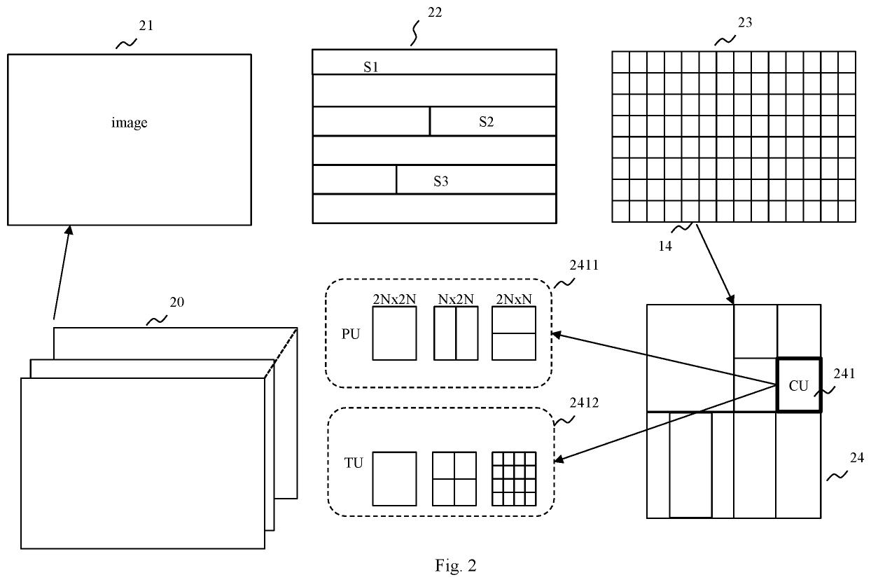

FIGS. 2, 3 and 4 introduce an example of video format.

FIG. 2 illustrates an example of partitioning undergone by a picture of pixels 21 of an original video 20. It is considered here that a pixel is composed of three components: a luminance component and two chrominance components. Other types of pixels are however possible comprising more components such as an additional depth component.

A picture is divided into a plurality of coding entities. First, as represented by reference 23 in FIG. 2, a picture is divided in a grid of blocks called coding tree units (CTU). A CTU consists of an N×N block of luminance samples together with two corresponding blocks of chrominance samples. Nis generally a power of two having a maximum value of “128” for example. Second, a picture is divided into one or more groups of CTU. For example, it can be divided into one or more tile rows and tile columns, a tile being a sequence of CTU covering a rectangular region of a picture. In some cases, a tile could be divided into one or more bricks, each of which consisting of at least one row of CTU within the tile. Above the concept of tiles and bricks, another encoding entity, called slice, exists, that can contain at least one tile of a picture or at least one brick of a tile.

In the example in FIG. 2, as represented by reference 22, the picture 21 is divided into three slices S1, S2 and S3 of the raster-scan slice mode, each comprising a plurality of tiles (not represented), each tile comprising only one brick.

As represented by reference 24 in FIG. 2, a CTU may be partitioned into the form of a hierarchical tree of one or more sub-blocks called coding units (CU). The CTU is the root (i.e. the parent node) of the hierarchical tree and can be partitioned in a plurality of CU (i.e. child nodes). Each CU becomes a leaf of the hierarchical tree if it is not further partitioned in smaller CU or becomes a parent node of smaller CU (i.e. child nodes) if it is further partitioned.

In the example of FIG. 2, the CTU 24 is first partitioned in “4” square CU using a quadtree type partitioning. The upper left CU is a leaf of the hierarchical tree since it is not further partitioned, i.e. it is not a parent node of any other CU. The upper right CU is further partitioned in “4” smaller square CU using again a quadtree type partitioning. The bottom right CU is vertically partitioned in “2” rectangular CU using a binary tree type partitioning. The bottom left CU is vertically partitioned in “3” rectangular CU using a ternary tree type partitioning.

During the coding of a picture, the partitioning is adaptive, each CTU being partitioned so as to optimize a compression efficiency of the CTU criterion.

In HEVC appeared the concept of prediction unit (PU) and transform unit (TU). Indeed, in HEVC, the coding entity that is used for prediction (i.e. a PU) and transform (i.e. a TU) can be a subdivision of a CU. For example, as represented in FIG. 2, a CU of size 2N×2N, can be divided in PU 2411 of size N×2N or of size 2N×N. In addition, said CU can be divided in “4” TU 2412 of size N×N or in “16” TU of size

$$( \frac{N}{2} ) \times ( \frac{N}{2} ) .$$

One can note that in VVC, except in some particular cases, frontiers of the TU and PU are aligned on the frontiers of the CU. Consequently, a CU comprises generally one TU and one PU.

In the present application, the term “block” or “picture block” can be used to refer to any one of a CTU, a CU, a PU and a TU. In addition, the term “block” or “picture block” can be used to refer to a macroblock, a partition and a sub-block as specified in H.264/AVC or in other video coding standards, and more generally to refer to an array of samples of numerous sizes.

In the present application, the terms “reconstructed” and “decoded” may be used interchangeably, the terms “pixel” and “sample” may be used interchangeably, the terms “image,” “picture”, “sub-picture”, “slice” and “frame” may be used interchangeably. Usually, but not necessarily, the term “reconstructed” is used at the encoder side while “decoded” is used at the decoder side.

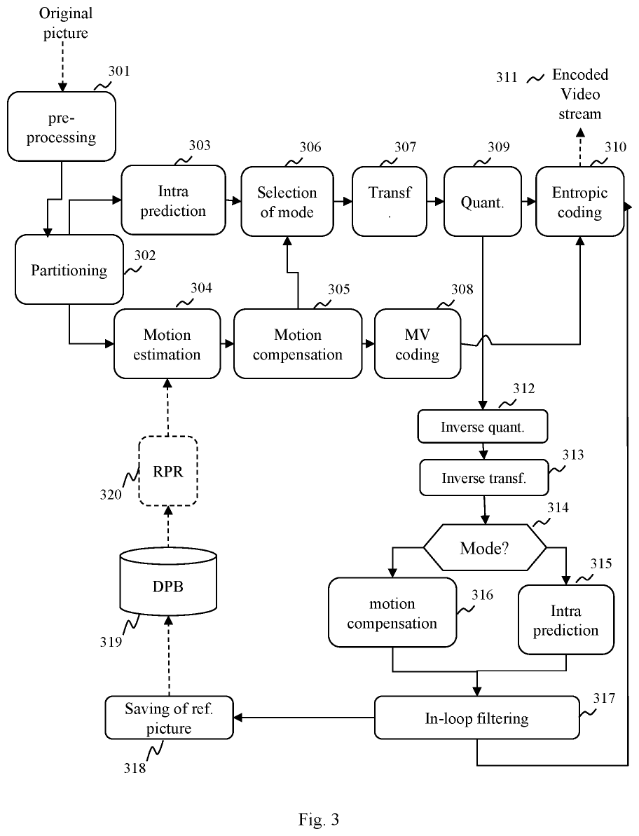

FIG. 3 depicts schematically a method for encoding a video stream executed by an encoding module. Variations of this method for encoding are contemplated, but the method for encoding of FIG. 3 is described below for purposes of clarity without describing all expected variations.

Before being encoded, a current original picture of an original video sequence may go through a pre-processing. For example, in a step 301, a color transform is applied to the current original picture (e.g., conversion from RGB 4:4:4 to YCbCr 4:2:0), or a remapping is applied to the current original picture components in order to get a signal distribution more resilient to compression (for instance using a histogram equalization of one of the color components). In addition, the pre-processing step 301 may comprise a resampling (a down-sampling or an up-sampling). The resampling may be applied to some pictures so that the generated bitstream may comprise pictures at the original size and pictures at another size. The resampling consists generally in a down-sampling and is used to reduce the bitrate of the generated bitstream. Nevertheless, up-sampling is also possible. The RPR tool allows managing resampled pictures during the motion estimation/compensation process. Pictures obtained by pre-processing are called pre-processed pictures in the following.

The encoding of a pre-processed picture begins with a partitioning of the pre-processed picture during a step 302, as described in relation to FIG. 2. The pre-processed picture is thus partitioned into CTU, CU, PU, TU, etc. For each block, the encoding module determines a coding mode between an intra prediction and an inter prediction.

The intra prediction consists of predicting, in accordance with an intra prediction method, during a step 303, the pixels of a current block from a prediction block derived from pixels of reconstructed blocks situated in a causal vicinity of the current block to be coded. The result of the intra prediction is a prediction direction indicating which pixels of the blocks in the vicinity to use, and a residual block resulting from a calculation of a difference between the current block and the prediction block.

The inter prediction consists in predicting the pixels of a current block of a current picture from a block of pixels, referred to as the reference block, of a picture preceding or following the current picture, this picture being referred to as the reference picture. During the coding of a current block in accordance with the inter prediction method, a block of the reference picture closest, in accordance with a similarity criterion, to the current block is determined by a motion estimation step 304. During step 304, a motion vector indicating the position of the reference block in the reference picture is determined. Said motion vector is used during a motion compensation step 305 during which a residual block is calculated in the form of a difference between the current block and the reference block. In general, the motion estimation and the motion compensation is done at a sub-pixel resolution, for instance at a 1/16 pixel resolution to insure a good precision of the motion vectors. Performing motion estimation and motion compensation at a sub-pixel resolution requires an interpolation of the current and reference picture.

In first video compression standards, the mono-directional inter prediction mode described above was the only inter mode available. As video compression standards evolve, the family of inter modes has grown significantly and comprises now many different inter modes.

During a selection step 306, the prediction mode optimising the compression performances, in accordance with a rate/distortion optimization criterion (i.e. RDO criterion), among the prediction modes tested (Intra prediction modes, Inter prediction modes), is selected by the encoding module.

When the prediction mode is selected, the residual block is transformed during a step 307 and quantized during a step 309. Note that the encoding module can skip the transform and apply quantization directly to the non-transformed residual signal. When the current block is coded according to an intra prediction mode, a prediction direction and the transformed and quantized residual block are encoded by an entropic encoder during a step 310. When the current block is encoded according to an inter prediction, when appropriate, a motion vector of the block is predicted from a prediction vector selected from a set of motion vectors corresponding to reconstructed blocks situated in the vicinity of the block to be coded. The motion information is next encoded by the entropic encoder during step 310 in the form of a motion residual and an index for identifying the prediction vector. The transformed and quantized residual block is encoded by the entropic encoder during step 310. Note that the encoding module can bypass both transform and quantization, i.e., the entropic encoding is applied on the residual without the application of the transform or quantization processes. The result of the entropic encoding is inserted in an encoded video stream 311.

An encoded video stream may comprise several headers such as a sequence header, at least one picture header and/or slice headers. The sequence header, also called sequence parameter set (SPS), comprises information common to all parts of the video sequence. For example, the SPS comprises, an information representative of a chroma format of the pictures in the sequence and an information representative of a relative location of chroma samples with respect to luma samples. The picture header refers to one picture parameter set (PPS) which comprises information common to several pictures of the video sequence but not necessarily common to all pictures of the video sequence. For example, the size of a picture may be signalled in the PPS. The slice header comprises information common to all blocks comprised in a slice. For instance, the slice header or picture header may comprise an index indicating which PPS shall be used to decode the slice.

Metadata such as SEI (supplemental enhancement information) messages can be attached to the encoded video stream 311. A SEI (Supplemental Enhancement Information) message as defined for example in standards such as AVC, HEVC or VVC is a data container associated to a video stream and comprising metadata providing information relative to the video stream.

After the quantization step 309, the current block is reconstructed so that the pixels corresponding to that block can be used for future predictions. This reconstruction phase is also referred to as a prediction loop. An inverse quantization is therefore applied to the transformed and quantized residual block during a step 312 and an inverse transformation is applied during a step 313. According to the prediction mode used for the block obtained during a step 314, the prediction block of the block is reconstructed. If the current block is encoded according to an inter prediction mode, the encoding module applies, when appropriate, during a step 316, a motion compensation using the motion vector of the current block in order to identify the reference block of the current block. If the current block is encoded according to an intra prediction mode, during a step 315, the prediction direction corresponding to the current block is used for reconstructing the reference block of the current block. The reference block and the reconstructed residual block are added in order to obtain the reconstructed current block.

Following the reconstruction, an in-loop filtering intended to reduce the encoding artefacts is applied, during a step 317, to the reconstructed block. This filtering is called in-loop filtering since this filtering occurs in the prediction loop to obtain at the decoder the same reference images as the encoder and thus avoid a drift between the encoding and the decoding processes. As mentioned earlier, in-loop filtering tools comprises deblocking filtering, SAO and ALF.

The purpose of deblocking filtering is to attenuate discontinuities at block boundaries due to the differences in quantisation between blocks. It is an adaptive filtering that can be activated or deactivated and, when it is activated, that can take the form of a high-complexity deblocking filtering based on a separable filter with a dimension comprising six filter coefficients, which is referred to hereinafter as strong deblocking filter (SDBF), and a low-complexity deblocking filtering based on a separable filter with one dimension comprising four coefficients, which is referred to hereinafter as weak deblocking filter (WDBF). The SDBF greatly attenuates discontinuities at the block boundaries, which may damage spatial high frequencies present in original pictures. The WDBF weakly attenuates discontinuities at the block boundaries, which makes it possible to preserve high spatial frequencies present in the original pictures but which will be less effective on discontinuities artificially created by the quantisation. The decision to filter or not to filter, and the form of the filter used in the event of filtering depend, among other things, on the value of the pixels at the boundaries of the block to be filtered.

Parameters representative of the deblocking filter are introduced in the encoded video stream 311 during the entropic coding step 310.

SAO filtering takes two classifiers having two different objectives. The purpose of the first classifier, referred to as edge offset, is to compensate for the effects of the quantisation on the edges in the blocks typically. SAO filtering by edge offset comprises a classification of the samples of the reconstructed image in accordance with four categories corresponding to four respective types of edge. Each type of edge is associated with an offset value that is added to the samples during the SAO filtering.

The second classifier of SAO is referred to as band offset and its purpose is to compensate for the effect of the quantisation of the samples belonging to certain ranges (i.e. bands) of values typically. In band-offset filtering, all the possible values for a sample, most frequently lying between “0” and “255” for 8-bit video streams, is divided into a plurality of bands of values (for example thirty-two bands of eight values).

Among this plurality of bands, a set of consecutive bands (for example four) are selected to be corrected with an offset. When a sample has a value lying in one of the consecutive bands of values to be offset, an offset value is added to the value of the sample. In the usual design of SAO, each component of a pixel (a.k.a each sample) is processed independently and doesn't take into consideration the strong correlations existing between the different components.

In a recent encoding tool, called Cross-Component Sample Adaptive Offset (CCSAO), proposed in document “C.-W. Kuo, X Xiu, Y.-W. Chen, H.-J. Jhu, W. Chen, X Wang, “AHG12: Cross-component Sample Adaptive Offset”, JVET-V0153, May 2021, Teleconference” and further described in document “Che-Wei Kuo, Xiaoyu Xiu, Yi-Wen Chen, Hong-Jheng Jhu, Wei Chen, Xianglin Wang, “EE2-5.1: Cross-component Sample Adaptive Offset,” document JVET-W0066, 23rd JVET Meeting, by teleconference, 7-16 Jul. 2021” these correlations are better considered. To do so, similar to SAO, the CCSAO tool classifies reconstructed pixels into different categories, properly derives one offset for each category and adds the offset to the reconstructed samples falling into that category. However, different from SAO which classifies each component of a pixel in a band without taking into account the other components, the CCSAO tool utilizes all three components to classify the current sample into the different categories.

More precisely, for a given pixel, three candidate samples are selected to classify the given pixel into different categories: one collocated luma sample Y_{col}, one collocated chroma sample U_{col}, and one collocated chroma sample V_{col}. The sample values of these three selected collocated samples are then classified into three different bands {band_{Y}, band_{U}, band_{V}}, and a joint index i is used to indicate the category of the given pixel:

$$\begin{matrix}{bandy}_{Y} = ( {Y}_{col} \cdot {N}_{Y} ) ≫ BD \\ {bandy}_{U} = ( {U}_{col} \cdot {N}_{U} ) ≫ BD \\ {band}_{V} = ( {V}_{col} \cdot {N}_{V} ) ≫ BD \\ i = {band}_{Y} \cdot ( {N}_{U} \cdot {N}_{V} ) + {band}_{U} \cdot {N}_{V} + {band}_{V}\end{matrix}$$

wherein {N_{Y}, N_{U}, N_{V}} are numbers of equally divided bands applied to {Y_{col}, U_{col}, V_{col}} full range respectively and BD is an internal coding bit-depth.

For some categories, one offset is signaled and added to the reconstructed samples that fall into that category, which can be formulated as:

$${C}_{rec}^{′} = Clip 1 ( {C}_{rec} + {σ}_{CCSAO} [ i ] )$$

C_{rec} and C′_{rec} are respectively a reconstructed sample before and after the CCSAO is applied. σ_{CCSAO}[i] is a value of CCSAO offset applied to the samples of the i-th category.

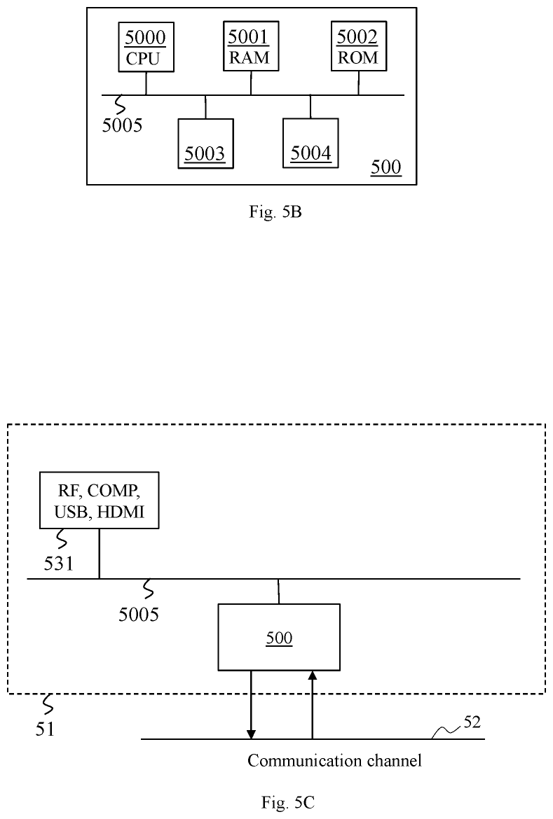

In the current design, the collocated luma sample Y_{col} can be chosen from nine candidate positions, while the collocated chroma samples (U_{col} and V_{col}) positions are fixed, as depicted in FIG. 6. FIG. 6 represents a plurality of positions that can be taken by a luma sample (on the left part) compared to fixed positions of chroma samples (in the middle and right parts). One motivation of this design of CCSAO is intended to compensate effects of an eventual difference of size between luma and chroma components. Indeed, when down-sampling the chroma, one has to choose the location of the chroma samples relatively to the original and luma samples. The chroma samples positions may not be strictly aligned with the central position (4 in FIG. 6) but closer to positions “0”, “1”, “2”, “3”, “5”, “6”, “7” or “8”. The candidate position offering the best rate-distortion compromise is selected in the set of nine positions and transmitted in the bitstream.

Similarly to SAO, CCSAO is applied on the encoder side in step 317 and on the decoder side in step 417.

The decision to use SAO filtering and, when SAO filtering is used, the type of the SAO filtering (between SAO edge offset, SAO band offset and/or CCSAO) and the SAO parameters, such as the offset values, are determined for each CTU during the encoding process by means of a rate/distortion optimisation.

Parameters representative of the activation or the deactivation of SAO/CCSAO and when activated, of characteristics of SAO/CCSAO are introduced in the encoded video stream 311 at the slice and block level during the entropic coding step 310.

The purpose of ALF is to minimize a mean square error between original samples and decoded samples by using Wiener-based adaptive filters (note that ALF can be used for other purpose, but is in general tuned by the encoder for minimizing the mean square error). ALF is located at the last processing stage for each picture and can be regarded as a tool to catch and fix artifacts from previous stages. The ALF process consists in selecting one among a “25” filters for each 4×4 block of an image. To do so, each block is classified into one among “25” categories based on a direction and an activity of local gradients. Each filter is derived from a diamond shape filter. ALF filter parameters are signaled in Adaptation Parameter Set (APS), an APS being a container for transporting some encoding parameters. In one APS, up to “25” sets of luma filter coefficients and clipping value indexes, and up to eight sets of chroma filter coefficients and clipping value indexes could be signaled. To reduce bits overhead, filter coefficients of different classification for luma component can be merged. In slice header, the indices of the APSs used for a current slice are signaled.

In a slice header, up to “7” APS indices can be signaled to specify the luma filter sets that are used for the current slice. The filtering process can be further controlled at the block level. A flag is always signaled to indicate whether ALF is applied to a luma block. A luma block can choose a filter set among “16” fixed filter sets and the filter sets from APSs. A filter set index is signaled for a luma block to indicate which filter set is applied. The “16” fixed filter sets are pre-defined and hard-coded in both the encoder and the decoder.

For chroma component, an APS index is signaled in slice header to indicate the chroma filter sets being used for the current slice. At block level, a filter index is signaled for each chroma block if there is more than one chroma filter set in the APS. When a block is reconstructed, it is inserted during a step 318 into a reconstructed picture stored in a memory 319 of reconstructed images corresponding to the DPB. The reconstructed images thus stored can then serve as reference images for other images to be coded.

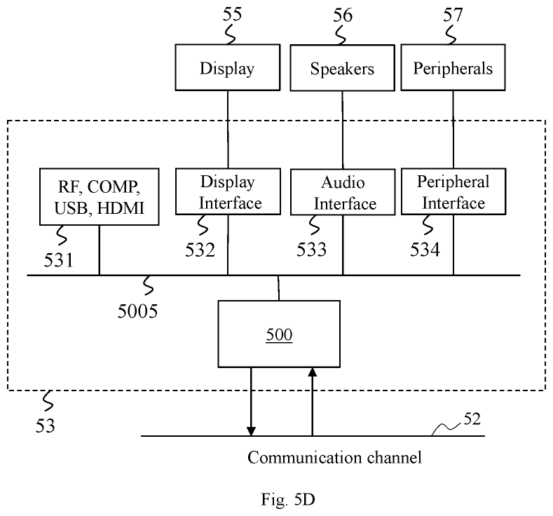

When RPR is used, luma and chroma samples from (i.e. at least a portion of) pictures stored in the DPB are resampled in a step 320 when used for motion estimation and compensation. Indeed, when a coding unit of a current picture is coded in inter mode from a reference picture, a reference scaling ratio pair RS(RscaleX;RscaleY) which is composed of a ratio between a width of the current picture and a width of the reference picture (RscaleX) and a ratio between a height of the current picture and a height of the reference picture (RscaleY) respectively, is determined. Each component is resampled separately. The reference scaling ratio RS and the sub-pel motion vector allows computing, for each component, the horizontal and vertical phases and to select coefficients of a resampling filters used by the motion compensation process to build a prediction block. When the reference scaling ratio RS is equal to (1;1), the phase is the same for all the prediction samples of a component and depends on the motion vector value only. When the reference scaling ratio RS is not equal to (1;1), the phase in a component may vary per prediction sample depending on the value of the reference scaling ratio RS, the motion vector and the position of the considered prediction sample. However, the same reference scaling ratio is always considered whatever the component is. FIG. 7 represents horizontal phases applied to prediction samples in a line of a picture for a reference scaling ratio RS equal to (1;1) and a reference scaling ratio RS equal to (0.66;0.66).

In some implementations, the resampling step (320) and sub-pixel interpolation step of the motion compensation step (305) can be combined in one single resampling-interpolation step, i.e. the reference scaling ratio RS and the sub-pel motion vector allow computing together, for each sample of each component, the horizontal and vertical phases and to select coefficients of the horizontal and vertical filters allowing obtaining directly a resampled and interpolated prediction block. Indeed, as shown in FIG. 7, the phase may vary with location of the sample prediction. Again, the same reference scaling ratio is always considered whatever the component is.

As already mentioned above, in the current design of RPR, the same resampling ratio is applied to luma and chroma components. One possible effect of applying the same resampling step (or combined resampling-interpolation step) to luma and chroma when the resampling is a down-sampling is to accentuate the down-sampling of chroma components that have been already down-sampled.

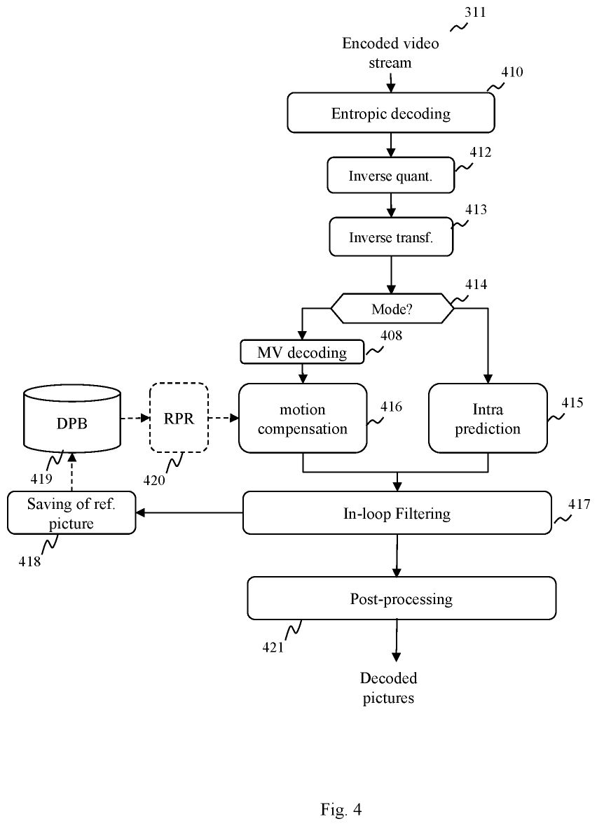

FIG. 4 depicts schematically a method for decoding the encoded video stream 311 encoded according to method described in relation to FIG. 3 executed by a decoding module. Variations of this method for decoding are contemplated, but the method for decoding of FIG. 4 is described below for purposes of clarity without describing all expected variations.

The decoding is done block by block. For a current block, it starts with an entropic decoding of the current block during a step 410. Entropic decoding allows to obtain the prediction mode of the block.

If the block has been encoded according to an inter prediction mode, the entropic decoding allows to obtain, when appropriate, a prediction vector index, a motion residual and a residual block. During a step 408, a motion vector is reconstructed for the current block using the prediction vector index and the motion residual.

If the block has been encoded according to an intra prediction mode, entropic decoding allows to obtain a prediction direction and a residual block. Steps 412, 413, 414, 415, 416 and 417 implemented by the decoding module are in all respects identical respectively to steps 312, 313, 314, 315, 316 and 317 implemented by the encoding module. Decoded blocks are saved in decoded pictures and the decoded pictures are stored in a DPB 419 in a step 418. When the decoding module decodes a given picture, the pictures stored in the DPB 419 are identical to the pictures stored in the DPB 319 by the encoding module during the encoding of said given picture. The decoded picture can also be outputted by the decoding module for instance to be displayed. When RPR is activated, samples of (i.e. at least a portion of) the picture used as reference pictures are resampled in step 420 to the size of the predicted picture. The resampling step (420) and motion compensation step (416) can be in some implementations combined in one single sample interpolation step.

The decoded image can further go through post-processing in step 421. The post-processing can comprise an inverse color transform (e.g. conversion from YCbCr 4:2:0 to RGB 4:4:4), an inverse mapping performing the inverse of the remapping process performed in the pre-processing of step 301, a post-filtering for improving the reconstructed pictures based for example on filter parameters provided in a SEI message and/or a resampling for example for adjusting the output pictures to display constraints.

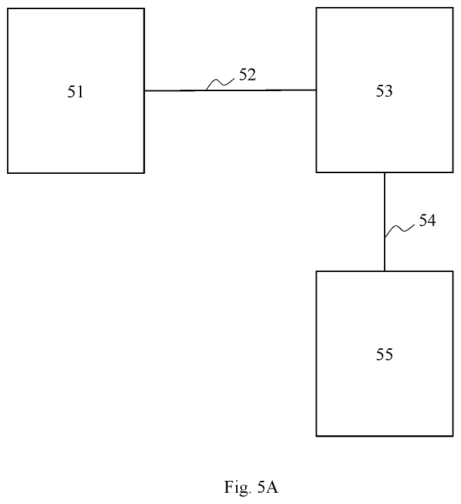

FIG. 5A describes an example of a context in which following embodiments can be implemented.

In FIG. 4A, a system 51, that could be a camera, a storage device, a computer, a server or any device capable of delivering a video stream, transmits a video stream to a system 53 using a communication channel 52. The video stream is either encoded and transmitted by the system 51 or received and/or stored by the system 51 and then transmitted. The communication channel 52 is a wired (for example Internet or Ethernet) or a wireless (for example WiFi, 3G, 4G or 5G) network link.

The system 53, that could be for example a set top box, receives and decodes the video stream to generate a sequence of decoded pictures.

The obtained sequence of decoded pictures is then transmitted to a display system 55 using a communication channel 54, that could be a wired or wireless network. The display system 55 then displays said pictures.

In an embodiment, the system 53 is comprised in the display system 55. In that case, the system 53 and display 55 a comprised in a TV, a computer, a tablet, a smartphone, a head-mounted display, etc.

FIG. 5B illustrates schematically an example of hardware architecture of a processing module 500 able to implement an encoding module or a decoding module capable of implementing respectively a method for encoding of FIG. 3 and a method for decoding of FIG. 4 modified according to different aspects and embodiments. The encoding module is for example comprised in the system 51 when this apparatus is in charge of encoding the video stream. The decoding module is for example comprised in the system 53. The processing module 500 comprises, connected by a communication bus 5005: a processor or CPU (central processing unit) 5000 encompassing one or more microprocessors, general purpose computers, special purpose computers, and processors based on a multi-core architecture, as non-limiting examples; a random access memory (RAM) 5001; a read only memory (ROM) 5002; a storage unit 5003, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive, or a storage medium reader, such as a SD (secure digital) card reader and/or a hard disc drive (HDD) and/or a network accessible storage device; at least one communication interface 5004 for exchanging data with other modules, devices or equipment. The communication interface 5004 can include, but is not limited to, a transceiver configured to transmit and to receive data over a communication channel. The communication interface 5004 can include, but is not limited to, a modem or network card.

If the processing module 500 implements a decoding module, the communication interface 5004 enables for instance the processing module 500 to receive encoded video streams and to provide a sequence of decoded pictures. If the processing module 500 implements an encoding module, the communication interface 5004 enables for instance the processing module 500 to receive a sequence of original video data to encode and to provide an encoded video stream.

The processor 5000 is capable of executing instructions loaded into the RAM 5001 from the ROM 5002, from an external memory (not shown), from a storage medium, or from a communication network. When the processing module 500 is powered up, the processor 5000 is capable of reading instructions from the RAM 5001 and executing them. These instructions form a computer program causing, for example, the implementation by the processor 5000 of a decoding method as described in relation with FIG. 4 or an encoding method described in relation to FIG. 3, the decoding and encoding methods comprising various aspects and embodiments described below in this document.

All or some of the algorithms and steps of said encoding or decoding methods may be implemented in software form by the execution of a set of instructions by a programmable machine such as a DSP (digital signal processor) or a microcontroller, or be implemented in hardware form by a machine or a dedicated component such as a FPGA (field-programmable gate array) or an ASIC (application-specific integrated circuit).

FIG. 5D illustrates a block diagram of an example of the system 53 in which various aspects and embodiments are implemented. The system 53 can be embodied as a device including the various components described below and is configured to perform one or more of the aspects and embodiments described in this document. Examples of such devices include, but are not limited to, various electronic devices such as personal computers, laptop computers, smartphones, tablet computers, digital multimedia set top boxes, digital television receivers, personal video recording systems, connected home appliances and head mounted displays. Elements of system 53, singly or in combination, can be embodied in a single integrated circuit (IC), multiple ICs, and/or discrete components. For example, in at least one embodiment, the system 53 comprises one processing module 500 that implements a decoding module. In various embodiments, the system 53 is communicatively coupled to one or more other systems, or other electronic devices, via, for example, a communications bus or through dedicated input and/or output ports. In various embodiments, the system 53 is configured to implement one or more of the aspects described in this document.

The input to the processing module 500 can be provided through various input modules as indicated in block 531. Such input modules include, but are not limited to, (i) a radio frequency (RF) module that receives an RF signal transmitted, for example, over the air by a broadcaster, (ii) a component (COMP) input module (or a set of COMP input modules), (iii) a Universal Serial Bus (USB) input module, and/or (iv) a High Definition Multimedia Interface (HDMI) input module. Other examples, not shown in FIG. 5D, include composite video.

In various embodiments, the input modules of block 531 have associated respective input processing elements as known in the art. For example, the RF module can be associated with elements suitable for (i) selecting a desired frequency (also referred to as selecting a signal, or band-limiting a signal to a band of frequencies), (ii) down-converting the selected signal, (iii) band-limiting again to a narrower band of frequencies to select (for example) a signal frequency band which can be referred to as a channel in certain embodiments, (iv) demodulating the down-converted and band-limited signal, (v) performing error correction, and (vi) demultiplexing to select the desired stream of data packets. The RF module of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down-converting the received signal to a lower frequency (for example, an intermediate frequency or a near-baseband frequency) or to baseband. In one set-top box embodiment, the RF module and its associated input processing element receives an RF signal transmitted over a wired (for example, cable) medium, and performs frequency selection by filtering, down-converting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF module includes an antenna.

Additionally, the USB and/or HDMI modules can include respective interface processors for connecting system 53 to other electronic devices across USB and/or HDMI connections. It is to be understood that various aspects of input processing, for example, Reed-Solomon error correction, can be implemented, for example, within a separate input processing IC or within the processing module 500 as necessary. Similarly, aspects of USB or HDMI interface processing can be implemented within separate interface ICs or within the processing module 500 as necessary. The demodulated, error corrected, and demultiplexed stream is provided to the processing module 500.

Various elements of system 53 can be provided within an integrated housing. Within the integrated housing, the various elements can be interconnected and transmit data therebetween using suitable connection arrangements, for example, an internal bus as known in the art, including the Inter-IC (I2C) bus, wiring, and printed circuit boards. For example, in the system 53, the processing module 500 is interconnected to other elements of said system 53 by the bus 5005.

The communication interface 5004 of the processing module 500 allows the system 53 to communicate on the communication channel 52. As already mentioned above, the communication channel 52 can be implemented, for example, within a wired and/or a wireless medium.

Data is streamed, or otherwise provided, to the system 53, in various embodiments, using a wireless network such as a Wi-Fi network, for example IEEE 802.11 (IEEE refers to the Institute of Electrical and Electronics Engineers). The Wi-Fi signal of these embodiments is received over the communications channel 52 and the communications interface 5004 which are adapted for Wi-Fi communications. The communications channel 52 of these embodiments is typically connected to an access point or router that provides access to external networks including the Internet for allowing streaming applications and other over-the-top communications. Other embodiments provide streamed data to the system 53 using the RF connection of the input block 531. As indicated above, various embodiments provide data in a non-streaming manner. Additionally, various embodiments use wireless networks other than Wi-Fi, for example a cellular network or a Bluetooth network.

The system 53 can provide an output signal to various output devices, including the display system 55, speakers 56, and other peripheral devices 57. The display system 55 of various embodiments includes one or more of, for example, a touchscreen display, an organic light-emitting diode (OLED) display, a curved display, and/or a foldable display. The display 55 can be for a television, a tablet, a laptop, a cell phone (mobile phone), a head mounted display or other devices. The display system 55 can also be integrated with other components (for example, as in a smart phone), or separate (for example, an external monitor for a laptop). The other peripheral devices 57 include, in various examples of embodiments, one or more of a stand-alone digital video disc (or digital versatile disc) (DVR, for both terms), a disk player, a stereo system, and/or a lighting system. Various embodiments use one or more peripheral devices 57 that provide a function based on the output of the system 53. For example, a disk player performs the function of playing an output of the system 53.

In various embodiments, control signals are communicated between the system 53 and the display system 55, speakers 56, or other peripheral devices 57 using signaling such as AV.Link, Consumer Electronics Control (CEC), or other communications protocols that enable device-to-device control with or without user intervention. The output devices can be communicatively coupled to system 53 via dedicated connections through respective interfaces 532, 533, and 534. Alternatively, the output devices can be connected to system 53 using the communications channel 52 via the communications interface 5004 or a dedicated communication channel corresponding to the communication channel 54 in FIG. 5A via the communication interface 5004. The display system 55 and speakers 56 can be integrated in a single unit with the other components of system 53 in an electronic device such as, for example, a television. In various embodiments, the display interface 532 includes a display driver, such as, for example, a timing controller (T Con) chip.

The display system 55 and speaker 56 can alternatively be separate from one or more of the other components. In various embodiments in which the display system 55 and speakers 56 are external components, the output signal can be provided via dedicated output connections, including, for example, HDMI ports, USB ports, or COMP outputs.

FIG. 5C illustrates a block diagram of an example of the system 51 in which various aspects and embodiments are implemented. System 51 is very similar to system 53. The system 51 can be embodied as a device including the various components described below and is configured to perform one or more of the aspects and embodiments described in this document. Examples of such devices include, but are not limited to, various electronic devices such as personal computers, laptop computers, smartphones, tablet computers, a camera and a server. Elements of system 51, singly or in combination, can be embodied in a single integrated circuit (IC), multiple ICs, and/or discrete components. For example, in at least one embodiment, the system 51 comprises one processing module 500 that implements an encoding module. In various embodiments, the system 51 is communicatively coupled to one or more other systems, or other electronic devices, via, for example, a communications bus or through dedicated input and/or output ports. In various embodiments, the system 51 is configured to implement one or more of the aspects described in this document.

The input to the processing module 500 can be provided through various input modules as indicated in block 531 already described in relation to FIG. 5D.

Various elements of system 51 can be provided within an integrated housing. Within the integrated housing, the various elements can be interconnected and transmit data therebetween using suitable connection arrangements, for example, an internal bus as known in the art, including the Inter-IC (I2C) bus, wiring, and printed circuit boards. For example, in the system 51, the processing module 500 is interconnected to other elements of said system 51 by the bus 5005.

The communication interface 5004 of the processing module 500 allows the system 51 to communicate on the communication channel 52.

Data is streamed, or otherwise provided, to the system 51, in various embodiments, using a wireless network such as a Wi-Fi network, for example IEEE 802.11 (IEEE refers to the Institute of Electrical and Electronics Engineers). The Wi-Fi signal of these embodiments is received over the communications channel 52 and the communications interface 5004 which are adapted for Wi-Fi communications. The communications channel 52 of these embodiments is typically connected to an access point or router that provides access to external networks including the Internet for allowing streaming applications and other over-the-top communications. Other embodiments provide streamed data to the system 51 using the RF connection of the input block 531.

As indicated above, various embodiments provide data in a non-streaming manner. Additionally, various embodiments use wireless networks other than Wi-Fi, for example a cellular network or a Bluetooth network.

The data provided to the system 51 can be provided in different format. In various embodiments these data are encoded and compliant with a known video compression format such as AV1, VP9, VVC, HEVC, AVC, etc. In various embodiments, these data are raw data provided by a picture (and optionally audio) acquisition module connected to the system 51 or comprised in the system 51. In that case, the processing module take in charge the encoding of these data.

The system 51 can provide an output signal to various output devices capable of storing and/or decoding the output signal such as the system 53.

Various implementations involve decoding. “Decoding”, as used in this application, can encompass all or part of the processes performed, for example, on a received encoded video stream in order to produce a final output suitable for display. In various embodiments, such processes include one or more of the processes typically performed by a decoder, for example, entropy decoding, inverse quantization, inverse transformation, and prediction. In various embodiments, such processes also, or alternatively, include processes performed by a decoder of various implementations described in this application, for example, for determining a size of the chroma components when RPR is applied or for applying CCSOA when the chroma format is not 4:2:0.

Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on input video data in order to produce an encoded video stream. In various embodiments, such processes include one or more of the processes typically performed by an encoder, for example, partitioning, prediction, transformation, quantization, and entropy encoding. In various embodiments, such processes also, or alternatively, include processes performed by an encoder of various implementations described in this application, for example, for determining a size of the chroma components when RPR is applied or for applying CCSAO when the chroma format is not 4:2:0.

Whether the phrase “encoding process” is intended to refer specifically to a subset of operations or generally to the broader encoding process will be clear based on the context of the specific descriptions and is believed to be well understood by those skilled in the art.

Note that the syntax elements names as used herein, are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to rate distortion optimization. In particular, during the encoding process, the balance or trade-off between a rate and a distortion is usually considered. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of a reconstructed signal after coding and decoding. Faster approaches may also be used, to save encoding complexity, in particular with computation of an approximated distortion based on a prediction or a prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, a device, an apparatus or program). An apparatus can be implemented in, for example, appropriate hardware, software, and firmware. The methods can be implemented, for example, in a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, retrieving the information from memory or obtaining the information for example from another device, module or from user.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, “one or more of” for example, in the cases of “A/B”, “A and/or B” and “at least one of A and B”, “one or more of A and B” is intended to encompass the selection of the first listed option (A) only, or the selection of the second listed option (B) only, or the selection of both options (A and B). As a further example, in the cases of “A, B, and/or C” and “at least one of A, B, and C”, “one or more of A, B and C” such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a use of some coding tools. In this way, in an embodiment the same parameters can be used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the encoded video stream and SEI messages of a described embodiment. Such a signal can be formatted, for example, as an electromagnetic wave (for example, using a radio frequency portion of spectrum) or as a baseband signal. The formatting can include, for example, encoding an encoded video stream (or bitstream) and modulating a carrier with the encoded video stream. The information that the signal carries can be, for example, analog or digital information. The signal can be transmitted over a variety of different wired or wireless links, as is known. The signal can be stored on a processor-readable medium.

Various embodiments may refer to a bitstream (or similarly a stream). Bitstreams include, for example, any series or sequence of bits, and do not require that the data bits be, for example, transmitted, received, or stored.

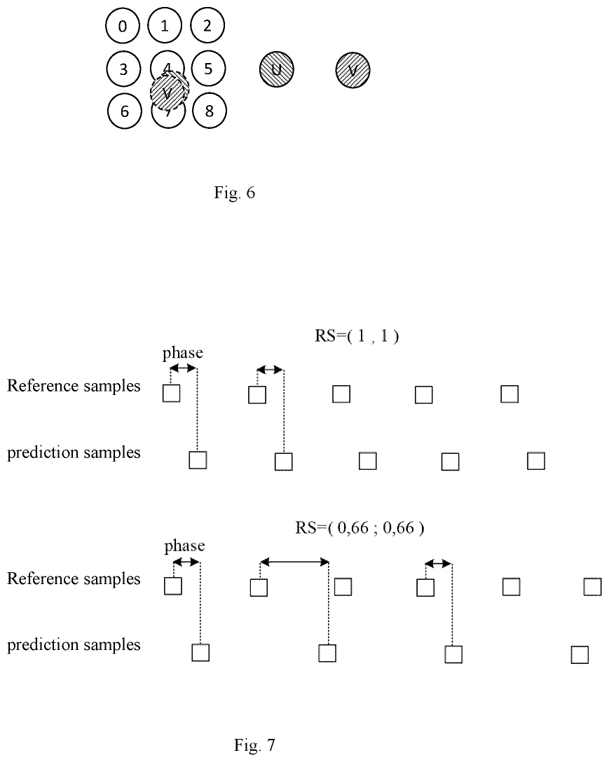

FIG. 8 illustrates schematically an example of method for encoding a video sequence comprising at least two different chroma formats.

The method of FIG. 8 represents some details of the method of FIG. 3 and is executed by the processing module 500 of the system 51.

In a step 801, the processing module 500 of the system 51 obtains an original picture. The original picture has an original size and an original chroma format. For instance, the original size is 3840×2160 pixels and the original chroma format is 4:2:0 (i.e. the size of the luma component is 3840×2160 and the size of the two chroma components is 1920×1080). The original picture is for instance a YUV picture.

In a step 802, the processing module 500 of the system 51 determines if the original picture can be resampled during the encoding. In this embodiment, the resampling is a down-sampling, but a similar process could be applied when the resampling is an up-sampling. For instance, the processing module determines an average variance of the picture and if the variance is below a predefined threshold, determines that a resampling can be applied to the current picture. If a resampling can be applied to the original picture, step 802 is followed by a step 803. Otherwise, step 802 is followed by a step 805.

In step 803, the processing module 500 of the system 51, applies a resampling to the luma component of the original picture using a first resampling ratio RRₗᵤₘₐ. In an embodiment, a resampling ratio is defined by two components. A first component RRH defines how the samples are resampled in the horizontal dimension (ratio between the width of the original picture and the width of the resampled picture). A second component RRV defines how the samples are resampled in the vertical dimension (ratio between the height of the original picture and the height of the resampled picture). For instance, the first resampling ratio RRₗᵤₘₐ is equal to (RRH=2, RRV=2). The size of the luma component resulting from the resampling with the first resampling ratio RRₗᵤₘₐ is therefore 1920×1080.

In step 804, the processing module 500 of the system 51, applies a resampling to the two chroma components of the original picture using a second resampling ratio RR_{chroma} different from the first resampling ratio RRₗᵤₘₐ. For instance, the second resampling ratio RR_{chroma} is equal to (RRH=1,5, RRV=1,5). The size of the chroma resulting from the resampling with the second resampling ratio RR_{chroma} is therefore 1280×720.

The combination of the resampled versions of the luma and chroma components of the original picture allows obtaining a resampled picture with a size equal to 1920×1080 and a chroma format equal to 4:3/2:3/2 (i.e. the size of the luma is 1920×1080 and the size of the chroma is 1280×720).

Note that steps 801 to 804 are performed during step 301 of FIG. 3.

Steps 801 to 804 are followed by the various encoding steps described in relation to FIG. 3. During these steps, the original picture or the resampled picture is called current picture. The current picture is the picture to be encoded.

Step 805 is executed during these steps, in particular, during the generation of a portion of the encoded video stream 311 corresponding to the current picture.

In step 805, the processing module 500 of the system 51 signals the chroma format of the current picture in the encoded video stream 311.

In a first embodiment of step 805, the processing module 500 of the system 51 inserts a syntax element pps_chroma_format_idc in the PPS to which refer the slice(s) of the current picture.

TABLE TAB1

| | Chroma |
|---|---|
| pps_chroma_format_idc | format |
| 0 | Monochrome |
| 1 | 4:2:0 |
| 2 | 4:2:2 |
| 3 | 4:4:4 |
| 4 | 4:3/2:3/2 |
| 6 | 4:4/3:4/3 |
| 7 | Other |

Table TAB1 represents the possible values that can be taken by the syntax element pps_chroma_format_idc. As can be seen, the 4:3/2:3/2 chroma format is added to the usual Monochrome, 4:2:0, 4:2:2 and 4:4:4 chroma formats, and open the possibility to a chroma format defined by other means than the syntax element pps_chroma_format_idc or an SPS level syntax element called SPS_chroma_format_idc. The chroma format 4:4/3:4/3 allows obtaining a picture for instance with a size of the luma component equal to 1280×720 and a size of the chroma components equal to 960×540. The other means allowing defining a chroma format could be a SEI message, a picture header or a slice header for example.

When step 805 follows directly step 802, two variants of the first embodiment of step 805 are possible.

In a first variant, the processing module 500 of the system 51 inserts the syntax element pps_chroma_format_idc in the PPS to which refer the slice(s) of the current picture to indicate explicitly the chroma format of the current picture.

In a second variant, the processing module 500 of the system 51 doesn't insert the syntax element pps_chroma_format_idc in the PPS to which refer the slice(s) of the current picture. If no syntax element pps_chroma_format_idc is present in the PPS, it is considered that the chroma format is the chroma format specified by the syntax element sps_chroma_format_idc in the SPS.

In a third variant of the first embodiment of step 805, no syntax element sps_chroma_format_idc is present in the SPS. In that case, the chroma format of pictures is exclusively specified by the syntax element pps_chroma_format_idc in the PPS.

In a fourth variant of the first embodiment of step 805, the syntax element sps_chroma_format_idc is present in the SPS. In that case, the chroma format of pictures is specified by the syntax element pps_chroma_format_idc in the PPS and the syntax element sps_chroma_format_idc specifies the chroma format of the original pictures or the chroma format corresponding to the largest picture size that can be found in the encoded video stream.

In another variant, the current picture refers to a PPS but refers also to a picture header or slice header. In that case, the current picture chroma format is coded in the picture header or a slice header.

In a second embodiment of step 805, the processing module 500 of the system 51 signals implicitly the chroma format of the current picture using the syntax element sps_chroma_format_idc specifying a chroma format in the SPS, from the largest picture size in the video sequence and information representative of the current picture size in the PPS to which refer the slice(s) of the current picture. The largest picture size and the picture size of the current picture are sufficient to deduce the first resampling ratio RRₗᵤₘₐ on a decoder side. In this second embodiment, a predefined association known by the encoder and the decoder links each possible couple of sps_chroma_format_idc value and RRₗᵤₘₐ to a chroma format. Table TAB2 proposes an example of such association.

TABLE TAB2

| | | Chroma |
|---|---|---|
| sps_chroma_format_idc | RRₗᵤₘₐ | format |
| 4:2:0 | 1 | 4:2:0 |
| 4:2:2 | 1 | 4:2:2 |
| 4:4:4 | 1 | 4:4:4 |
| 4:2:0 | 2 | 4:3/2:3/2 |
| 4:2:2 | 2 | other |
| 4:4:4 | 2 | 4:4:4 |
| 4:2:0 | 4 | 4:4:4 |
| 4:2:2 | 4 | 4:4:4 |
| 4:4:4 | 4 | 4:4:4 |

For instance, in this table, when the syntax element sps_chroma_format_idc specifies a chroma format equal to 4:2:0 and the first resampling ratio RRₗᵤₘₐ is equal to “2”, the chroma format of the current picture is 4:3/2:3/2. When the syntax element sps_chroma_format_idc specify a chroma format equal to 4:2:2 and the first resampling ratio RRₗᵤₘₐ is equal to “2”, the chroma format of the current picture is defined by other means such as a SEI message. If the first resampling ratio RRₗᵤₘₐ is equal to “4”, the chroma format of the current picture is systematically 4:4:4. If the first resampling ratio RRₗᵤₘₐ is equal to “1”, the chroma format is the one specified by the syntax element sps_chroma_format_idc.

In an embodiment, a syntax element SPS_multiple_chroma_formats_allowed is inserted in the SPS indicating whether the chroma formats varies in the encoded video stream.

In a variant of step 805, the chroma format of the current picture are constrained to predefined values. It amounts, for example, at removing the chroma format “other” from tables TAB1 and TAB2.

In a variant of step 805, the chroma format of the current picture is compliant with allowed ratios between a width of the original picture and a width of the current picture and with allowed ratios between a height of the original picture and a height of the current picture.

As already mentioned, generally due to the down-sampling of the chroma samples, luma samples and chroma samples may not be aligned. This feature could be taken into account during the encoding to improve the coding efficiency. The location of the chroma samples with respect to the luma samples is generally specified in the SPS.

In step 806, the processing module 500 of the system 51 signals the location of the chroma samples with respect to the luma samples in the current picture in the encoded video stream 311. Similarly to step 805, step 806 is executed during the encoding steps described in relation to FIG. 3, in particular, during the generation of a portion of the encoded video stream 311 corresponding to the current picture.

In a first embodiment of step 806, the processing module 500 of the system 51 inserts a syntax element pps_chroma_sample_location_idc in the PPS to which refer the slice(s) of the current picture.

TABLE TAB3

| pps_chroma_sample_location_idc | location |
|---|---|
| 0 | Colocated |
| 1 | Centered |
| 2 | Location 1 |
| 3 | Location 2 |
| 4 | Location 3 |
| 5 | Location 4 |
| 6 | Location 5 |
| 7 | Other |

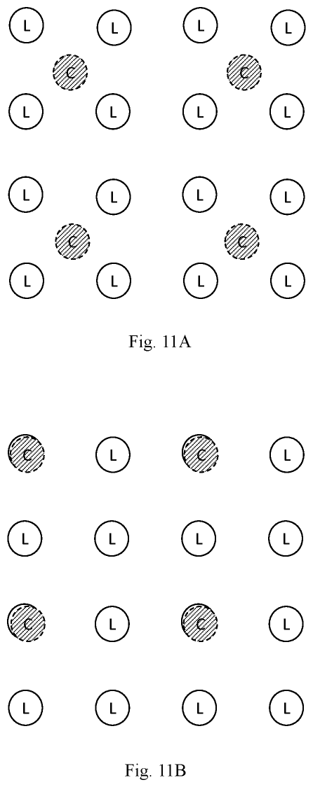

Table TAB3 represents the possible values that can be taken by the syntax element pps_chroma_sample_location_idc. As can be seen, a plurality of predefined locations is explicitly defined comprising the “colocated” location indicating that the chroma samples are aligned with the luma samples and a “centered” location indicating that the chroma samples are in-between luma samples. FIG. 11A represents schematically the centered location of chroma samples (noted “C” in the Fig.) in between the luma samples (noted “L” in the Fig.) when the chroma format is 4:2:0. As can be seen in FIG. 11A, the location of each chroma sample is in a middle of a square formed by four luma samples. FIG. 11B represents schematically the colocated location where chroma samples (noted “C” in the Fig.) are colocated with luma samples (noted “L” in the Fig.) when the chroma format is 4:2:0. As can be seen in FIG. 11B, the location of each chroma sample correspond to a location of a luma sample. “Other” indicates that the location of the chroma samples with respect to the luma samples in the current picture is defined by other means than the syntax element pps_chroma_sample_location_idc or is undefined. The other means allowing defining the location of the chroma samples with respect to the luma samples in the current picture could be a SEI message.

When step 806 follows directly step 802, two variants of the first embodiment of step 805 are possible.

In a first variant, the processing module 500 of the system 51 inserts the syntax element pps_chroma_sample_location_idc in the PPS to which refer the slice(s) of the current picture to indicate explicitly the location of the chroma samples with respect to the luma samples in the current picture.

In a second variant, the processing module 500 of the system 51 doesn't insert the syntax element pps_chroma_sample_location_idc in the PPS to which refer the slice(s) of the current picture. If no syntax element pps_chroma_sample_location_idc is present in the PPS, it is considered that the chroma samples are located at a default position, for instance aligned on the luma samples (which corresponds to the location “colocated” in table TAB3).

In a third variant of the first embodiment of step 806, no syntax element is present in the SPS to indicate the location of the chroma samples with respect to the luma samples in the current picture. In that case, the chroma format of pictures is exclusively specified by the syntax element pps_chroma_sample_location_idc in the PPS.

In a fourth variant of the first embodiment of step 806, a syntax element sps_chroma_sample_location_idc is present in the SPS to indicate a location of the chroma samples with respect to the luma samples. In that case, the location of the chroma samples with respect to the luma samples in pictures is specified by the syntax element pps_chroma_sample_location_idc in the PPS and the syntax element sps_chroma_sample_location_idc specifies the location of the chroma samples with respect to the luma samples in the original pictures or the location of the chroma samples with respect to the luma samples in pictures corresponding to the largest picture size that can be found in the encoded video stream.

In a fifth variant of the first embodiment of step 806, the syntax element pps_chroma_sample_location_idc is signaled in the PPS if the chroma format indicated by the syntax element sps_chroma_format_idc is different from the chroma format indicated by the syntax element sps_chroma_format_idc in the PPS to which refer the current picture. Otherwise, the location of the chroma samples with respect to the luma samples in the current picture is the one specified by the syntax element sps_chroma_sample_location_idc in the SPS.

In another variant, the syntax element pps_chroma_sample_location_idc is signaled in the picture header or a slice header.

In a second embodiment of step 806, the processing module 500 of the system 51 signals implicitly the chroma format of the current picture using the syntax element sps_chroma_sample_location_idc, from the largest picture size in the video sequence and information representative of the current picture size in the PPS to which refer the slice(s) of the current picture. Again, the largest picture size and the picture size of the current picture are sufficient to deduce the first resampling ratio RRₗᵤₘₐ on a decoder side. In this second embodiment of step 806, a predefined association known by the encoder and the decoder links each possible couple of sps_chroma_sample_location_idc value and RRₗᵤₘₐ to a chroma format. Table TAB4 proposes an example of such association.

TABLE TAB4

| sps_chroma_samples_location_idc | RRₗᵤₘₐ | Location |
|---|---|---|
| 4:2:0 | 1 | location 1 |
| 4:2:2 | 1 | location 2 |
| 4:4:4 | 1 | colocated |
| 4:2:0 | 2 | location 3 |
| 4:2:2 | 2 | location 4 |
| 4:4:4 | 2 | colocated |
| 4:2:0 | 4 | location 5 |
| 4:2:2 | 4 | location 6 |
| 4:4:4 | 4 | colocated |

For instance, in this table, when the syntax element sps_chroma_sample_location_idc specifies a chroma format equal to 4:2:0 and the first resampling ratio RRₗᵤₘₐ is equal to “2”, the chroma samples are at the location “3” with respect to the luma samples.

In an embodiment, if the chroma format signaled (implicitly or explicitly) for the current picture is 4:4:4, the location of the chroma samples with respect to the luma samples takes a default value. For instance, the default value is “collocated” (chroma samples are aligned (i.e. collocated) with luma samples.

In an embodiment, if the chroma format of the original picture is 4:2:0 or the chroma format specified by the syntax element sps_chroma_format_idc is 4:2:0 and the chroma format signaled (implicitly or explicitly) for the current picture is 4:4:4, the location of the chroma samples with respect to the luma samples in the current picture takes a default value. For instance, the default value is “collocated” (chroma samples are aligned (i.e. collocated) with luma samples. For another instance, the default value is “centered” in-between luma samples locations.

In an embodiment, a syntax element SPS_multiple_chroma_locations_allowed is inserted in the SPS indicating whether the locations of the chroma samples with respect to the luma samples varies in the encoded video stream.

In an embodiment of the method of FIG. 8, steps 805 and 806 are applied by the processing module 500 of the system 51 after steps 801 to 804.

In an embodiment of the method of FIG. 8, steps 805 only is applied by the processing module 500 of the system 51 after steps 801 to 804.

In an embodiment of the method of FIG. 8, steps 806 only is applied by the processing module 500 of the system 51 after steps 801 to 804.

As can be seen, the method of FIG. 8 allows encoding a video sequence from original video data and comprises coding a first picture of the video sequence with a feature related to a chroma component of the first picture different from a same feature related to a chroma component of a second picture of the video sequence, the feature related to a chroma component being representative of a chroma format and/or of a relative position of chroma samples with respect to luma samples.

Here a sequence is defined as a set of consecutive pictures wherein temporal prediction is allowed between any couple of pictures of the set. In other words, all pictures of a sequence refer to a single SPS. For instance, here, the first picture and the second picture refer to the same SPS.

For example, in an embodiment, the second picture is a reference picture for the first picture.

In addition, the method of FIG. 8 comprises signaling, either explicitly or implicitly, for the first picture of the encoded video stream an information related to a chroma component of the first picture different from an information related to a chroma component of the second picture of the encoded video stream.

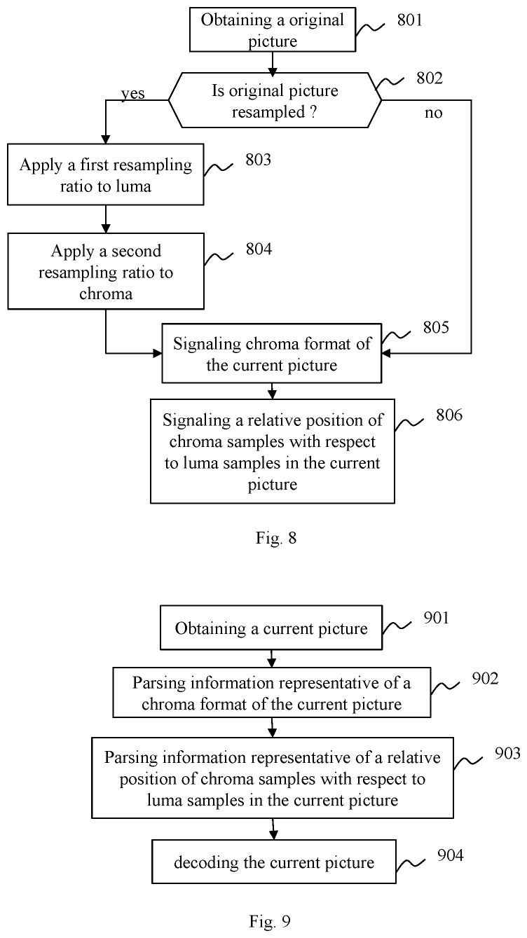

FIG. 9 illustrates schematically an example of method for decoding an encoded video sequence comprising at least two different chroma formats.

The method of FIG. 9 represents some details of the method of FIG. 4 and is executed by the processing module 500 of the system 53.

In a step 901, the processing module 500 of the system 53 obtains a bitstream comprising at least a portion representing a current picture. The processing module 500 of the system 53 has also access to a SPS and a PPS to which refer the current picture.

In a step 902, the processing module parses an information representative of a chroma format of the current picture.

In a first embodiment of step 902, the processing module tries to parse the syntax element pps_chroma_format_idc as described in relation to step 805 in the PPS.

If the syntax element pps_chroma_format_idc is present in the PPS, the processing module 500 of the system 53 parses the syntax element pps_chroma_format_idc. If the syntax element pps_chroma_format_idc is not present in the PPS, the processing module 500 of the system 53 deduces that the chroma format of the current picture is the one indicated by the syntax element sps_chroma_format_idc in the SPS.

In a second embodiment of step 902, the processing module 500 of the system 53 parses the syntax element sps_chroma_format_idc specifying a chroma format in the SPS, a syntax element representative of the largest picture size in the encoded video stream and a syntax element representative of the current picture size in the PPS and deduces the chroma format of the current picture from these syntax elements and from table TAB2.

In an embodiment, the processing module 500 of the system 53 parses the syntax element SPS_multiple_chroma_formats_allowed in the SPS.

In a step 903, the processing module 500 of the system 53 an information representative of the location of the chroma samples with respect to the luma samples in the current picture in the encoded video stream 311.

In a first embodiment of step 903, the processing module 500 of the system 53 tries to parse the syntax element pps_chroma_sample_location_idc in the PPS to which refer the slice(s) of the current picture.

If the syntax element pps_chroma_sample_location_idc is present in the PPS, the processing module 500 of the system 53 parses this syntax element.

If no syntax element pps_chroma_sample_location_idc is present in the PPS, the processing module 500 of the system 53 considers that the chroma samples location is default (ex: are aligned on the luma samples, which corresponds to the location “colocated” in table TAB3) or that the location of the chroma samples with respect to the luma samples is the one specified by the syntax element sps_chroma_sample_location_idc in the SPS.

In a second embodiment of step 903, the processing module 500 of the system 53 parses the syntax element sps_chroma_sample_location_idc, a syntax element representative of the largest picture size in the video sequence and a syntax element representative of the current picture size in the PPS to which refer the slice(s) of the current picture and determines from these syntax elements and from table TAB4 the relative location of the chroma samples with respect to the luma samples in the current picture.

In an embodiment, the processing module parses the syntax element SPS_multiple_chroma_locations_allowed in the SPS

Of course, the application of step 902 (respectively 903) by the processing module 500 of the system 53 depends on the application of step 805 (respectively 806) by the processing module 500 of the system 51.

As can be seen, the method of FIG. 9 allows decoding a video sequence representing original video data comprising decoding a first picture of the video sequence having a feature related to a chroma component of the picture different from a same feature related to a chroma component of a second picture of the video sequence, the feature related to a chroma component being representative of a chroma format and/or of a relative position of chroma samples with respect to luma samples.

Again, a sequence is defined here as a set of consecutive pictures wherein temporal prediction is allowed between any couple of pictures of the set.

In an embodiment, the second picture is a reference picture for the first picture.

In addition, the method of FIG. 9 comprises parsing, for the first picture of the encoded video stream, an information related to a chroma component of the first picture that could be different from an information related to a chroma component of the second picture of the encoded video stream.

As already discussed above in the present document, the application of RPR, and in particular, the application of the resampling (or of the combined resampling and interpolation) of the reference picture in RPR depends on a reference scaling ratio pair RS(RscaleX;RscaleY). Indeed, the reference scaling ratio RS allows computing, for each component, phases and to select coefficients of a resampling filter (respectively of a single filter) used by the motion compensation process to build a resampled prediction block (respectively used by the motion compression process to build directly a resampled and interpolated prediction block). In the context of a sequence comprising various chroma format, it is no more possible to consider only one reference scaling ratio pair RS(RscaleX;RscaleY) for all components.

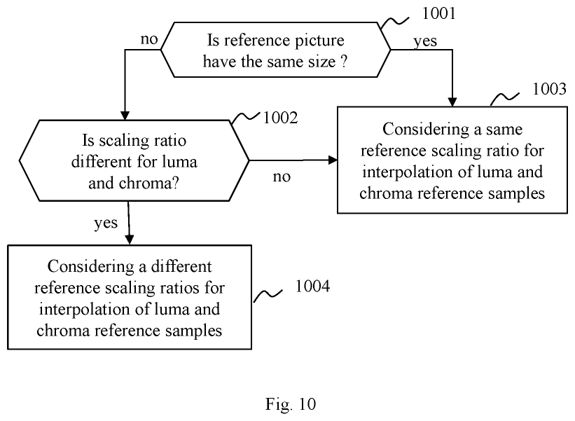

FIG. 10 illustrates schematically details on the application of RPR.

The process of FIG. 10 is applied either by the processing module 500 of the system 51 during the motion estimation/compensation steps (304/305 in FIG. 3) of the encoding process or by the processing module 500 of the system 53 during the motion compensation step (416 in FIG. 4) of the decoding process.

In a step 1001, the processing module 500 determines if the current picture have the same size than a reference picture used for temporal prediction of blocks of the current picture. We consider here that two pictures having the same size have the same chroma format.

If yes, the processing module 500 applies a step 1003. During step 1003, for each block of the current picture predicted in inter, the processing module 500 determines offsets and coefficients of a resampling filter (or a single filter) considering the same reference scaling ratio pair RS for the luma and the chroma (in this case, RS=(1;1)). For instance, the luma interpolation process described in section 8.5.6.3.2 and the chroma interpolation process described in section 8.5.6.3.4 of document JVET-T2001-v1, Versatil Video Coding Editorial Refinements on draft 10, Joint Video Experts Team (JVET) of ITU-T SGJ6 WP 3 and ISO IEC JTC 1/SC29, 20^{th} meeting, by teleconference, 7-16 Oct. 2020, just called JVET-T2001 in the following, are applied same reference scaling ratio pair RS. These two interpolation processes are applied during the motion compensation and are adapted to performed either and interpolation process or a combined resampling/interpolation process.

If the reference picture has a different size than the current picture, the processing module 500 applies a step 1002. In step 1002, the processing module 500 determines if the reference scaling ratio pair RS of the current picture is the same for luma and chroma (i.e. RSₗᵤₘₐ=RS_{chroma} where RSₗᵤₘₐ is the reference scaling ratio pair of the luma and RS_{chroma} is the reference scaling ratio pair of the chroma). If RSₗᵤₘₐ=RS_{chroma}, the processing module 500 applies step 1003 already described.

If RSₗᵤₘₐ #RS_{chroma}, the processing module applies a step 1004. During step 1004, for each block of the current picture predicted in inter, the processing module 500 determines offsets and coefficients of a resampling filter (or a single filter) considering the reference scaling ratio pair RSₗᵤₘₐ for the luma and the reference scaling ratio pair RS_{chroma} the chroma. For instance, the luma interpolation process described in sections 8.5.6.3.2 of document JVET-T2001 is applied with the reference scaling ratio pair RSₗᵤₘₐ and, the chroma interpolation process described in sections 8.5.6.3.4 of document JVET-T2001 is applied with the reference scaling ratio pair RS_{chroma}.

As seen above, CCSAO is a tool impacted by a difference of size between luma and chroma. In the current design of CCSAO, nine different positions (i.e. positions “0”, “1”, “2”, “3”, “5”, “6”, “7” or “8” in FIG. 6) of the luma sample are systematically tested to compensate an eventual drift between the luma sample and the chroma samples due to a resampling of chroma. When selected, the index of the selected position is encoded in the bitstream. Before entropy coding, the number of bits required to encode an index that can take nine different values is “4” bits which can be considered as a bad coding efficiency when it is not justified to have such granularity in the indices.

In particular, when the chroma format is 4:4:4, it is generally not necessary to test nine positions. The same applies to the chroma format 4:2:2.

In an embodiment, the number of positions and the position themselves depends on the chroma format in which is applied CCSAO.

In an embodiment:
The “9” positions of FIG. 6 are kept for 4:2:0;
Positions 0, 1, 2 and 6, 7 and 8 are kept for 4:2:2;
Only position 4 is kept for 4:4:4.

In that case, only 2 bits a required to encode the index in 4:2:0 and no bits is required for 4:4:4 since the single position is implicit.

In an embodiment, the single position for 4:4:4 is a default/implicit position known by the encoder and the decoder but not necessarily position 4.

We described above a number of embodiments. Features of these embodiments can be provided alone or in any combination. Further, embodiments can include one or more of the following features, devices, or aspects, alone or in any combination, across various claim categories and types:
A bitstream or signal resulting from the various embodiments, or variations thereof.
Creating and/or transmitting and/or receiving and/or decoding a bitstream or signal according to the various embodiments, or variations thereof.
A TV, set-top box, cell phone, smartphone, tablet, or other electronic device that performs at least one of the embodiments described.
A TV, set-top box, cell phone, smartphone, tablet, or other electronic device that performs at least one of the embodiments described, and that displays (e.g. using a monitor, screen, or other type of display) a resulting picture.
A TV, set-top box, cell phone, smartphone, tablet, or other electronic device that tunes (e.g. using a tuner) a channel to receive a signal including an encoded video stream, and performs at least one of the embodiments described.
A TV, set-top box, cell phone, tablet, or other electronic device that receives (e.g. using an antenna) a signal over the air that includes an encoded video stream, and performs at least one of the embodiments described.

1-22. (canceled)

23. A method comprising:
obtaining a reconstructed pixel of a picture;
classifying the reconstructed pixel into one category of a plurality of categories based on a value of a luma sample of the reconstructed pixel and values of chroma samples of the reconstructed pixel, the value of the luma sample depending on a candidate position of the luma sample in the picture selected in a set of candidate positions; and,
applying an offset to each sample of the reconstructed pixel based on the category in which is classified the reconstructed pixel, wherein:
a number of candidate positions in the set of candidate positions depends on a chroma format of the picture.

24. A device comprising an electronic circuitry configured for:
obtaining a reconstructed pixel of a picture;
classifying the reconstructed pixel into one category of a plurality of categories based on a value of a luma sample of the reconstructed pixel and values of chroma samples of the reconstructed pixel, the value of the luma sample depending on a candidate position of the luma sample in the picture selected in a set of candidate positions; and,
applying an offset to each sample of the reconstructed pixel based on the category in which is classified the reconstructed pixel, wherein:
a number of candidate positions in the set of candidate positions depends on a chroma format of the picture.

25. The method of claim 23, wherein the set comprises a single position when the chroma format is 4:4:4.

26. The method of claim 25, wherein the single position is a default position.

27. The method of claim 23, wherein the number of positions in the set is a function of a ratio between a number of chroma samples in the picture and a number of luma samples in the picture.

28. An encoding method comprising the method of claim 23.

29. A decoding method comprising the method of claim 23.

30-33. (canceled)

34. Non-transitory information storage medium storing program code instructions for implementing the method according to claim 23.

35. The device of claim 24, wherein the set comprises a single position when the chroma format is 4:4:4.

36. The device of claim 35, wherein the single position is a default position.

37. The device of claim 24, wherein the number of positions in the set is a function of a ratio between a number of chroma samples in the picture and a number of luma samples in the picture.

38. An encoding device comprising the device of claim 24.

39. A decoding device comprising the device of claim 24.
